(19) United States
(12) Patent Application Publication
(10) Pub. No.: US 2014/0184646 A1
(43) Pub. Date: Jul. 3, 2014

(54) IMAGE PROCESSOR AND FISHEYE IMAGE DISPLAY METHOD THEREOF

(71) Applicant: VIVOTEK INC., New Taipei (TW)

(72) Inventors: Chien-Wen LIU, New Taipei (TW); Teng-Kai KUO, New Taipei (TW)

(73) Assignee: VIVOTEK INC., New Taipei (TW)

(21) Appl. No.: 14/144,128

(22) Filed: Dec. 30, 2013

(30) Foreign Application Priority Data
Jan. 2, 2013 (TW) 102100019

(51) Int. Cl. G06T 11/60

(52) U.S. Cl. CPC G06T 11/60
USPC 345/634

(57) ABSTRACT

An image processor and a fisheye image display method thereof are provided, where the fisheye image display method performs the following steps. A fisheye image and part images are received, and each part image and the fisheye image have a relation therebetween. A frame layout with at least one cell is read. The fisheye image or part image is inserted in the cell. The frame layout is set as an output image. A modification command is received. A modification procedure is performed to modify the output image according to the modification command. Each part image and the fisheye image maintains the relation after the output image is modified.

### CROSS-REFERENCE TO RELATED APPLICATIONS

This non-provisional application claims priority under 35 U.S.C. §119(a) on Patent Application No(s). 102100019 filed in Taiwan, R.O.C. on Jan. 2, 2013, the entire contents of which are hereby incorporated by reference.

### TECHNICAL FIELD

This disclosure generally relates to an image processor and a display method, and more particularly to an image processor and a fisheye image display method thereof.

### BACKGROUND

Surveillance cameras are widely installed in offices, factories, stores, and even houses for remote security surveillance. In order to know the status of the entire environment, most surveillance cameras adopt fisheye lenses with an ultra wide view angle. If one wants to observe a specific area presented in an image, the range of the image needs to be adjusted manually until that specific area can be monitored in the image.

Generally, the surveillance camera cooperates with a surveillance program. Most surveillance programs in the market nowadays support lots of functions, making them complicated for users to operate. If the surveillance program cooperates with the surveillance camera with a fisheye lens, this surveillance program usually has more complicated setting processes and spends more setting time. Users are hard to operate the surveillance program. If being operated improperly, the surveillance program will not show desired images to users. Moreover, surveillance programs in today's market have low flexibilities in functions since there is usually only one or a few of the display modes for users to choose and sometimes the entire image cannot be adjusted or set after one display mode is chosen. Thus, users are heavily restricted by the operations of these surveillance programs during usage.

### SUMMARY

According to an embodiment, a fisheye image display method includes the following steps. A fisheye image and part images are received, and each part image and the fisheye image have a relation therebetween. A frame layout with at least one cell is read, and the fisheye image or at least one of the part images is inserted in the at least one cell. The frame layout is set as an output image. A modification command is received, and a modification procedure is performed according to the modification command to modify the output image. After the output image is modified, each part image and the fisheye image remain in the relation.

According to an embodiment, an image processor includes a storage unit for storing a fisheye image and part images, and a processing unit. Each part image and the fisheye image have a relation therebetween. The processing unit performs the following steps: receiving the fisheye image and the part images from the storage unit, reading a frame layout including at least one cell, inserting the fisheye image and at least one of the part images in the cell, setting the frame layout as an output image, receiving a modification command, and performing a modification procedure according to the modification command to modify the output image. Each part image and the fisheye image remain in the relation after the output image is modified.

### BRIEF DESCRIPTION OF THE DRAWINGS

FIG. 1 is a block diagram of an image processor in an embodiment;

FIG. 2 is a flow chart of a fisheye image display method in an embodiment;

FIG. 3A is a schematic diagram of an original fisheye image in an embodiment;

FIG. 3B is a schematic diagram of an unfolded fisheye image in an embodiment;

FIG. 3C is a schematic diagram of one part image in an embodiment;

FIG. 4A to 4F are schematic diagrams of frame layouts in different embodiments;

FIGS. 5A and 5B are schematic diagrams of inputting a modification command in an embodiment;

FIG. 6 is a flow chart of a modification procedure specified by an image shifting command in an embodiment;

FIGS. 7A and 7B are schematic diagrams of performing the image shifting command in an embodiment;

FIG. 8 is a flow chart of a modification procedure specified by a scaling command in an embodiment;

FIG. 9A is a schematic diagram of performing the scaling command in an embodiment;

FIG. 9B is a schematic diagram of performing the scaling command in an embodiment;

FIG. 10 is a flow chart of a modification procedure specified by a switch command in an embodiment;

FIGS. 11A and 11B are schematic diagrams of performing the switch command in an embodiment;

FIG. 12 is a flow chart of a modification procedure specified by a cell shifting command in an embodiment;

FIGS. 13A and 13B are schematic diagrams of performing the cell shifting command in an embodiment;

FIG. 14 is a flow chart of a modification procedure specified by a layout mode switch command in an embodiment;

FIGS. 15A and 15B are schematic diagrams of performing the layout mode switch command in an embodiment;

FIG. 16 is a flow chart of a modification procedure specified by a layout type switch command in an embodiment;

FIGS. 17A and 17B are schematic diagrams of performing the layout type switch command in different embodiments;

FIGS. 18A to 18C are schematic diagrams of layout modes in different embodiments;

FIG. 19 is a flow chart of a modification procedure specified by a cell deleting command in an embodiment; and

FIG. 20A to 20C are schematic diagrams of performing the cell deleting command in different embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The disclosure provides an image processor and a fisheye image display method thereof for displaying fisheye images or part images associated with the fisheye images, and the image processor can perform the fisheye image display method. The details of the image processor and fisheye image display method will be described below.

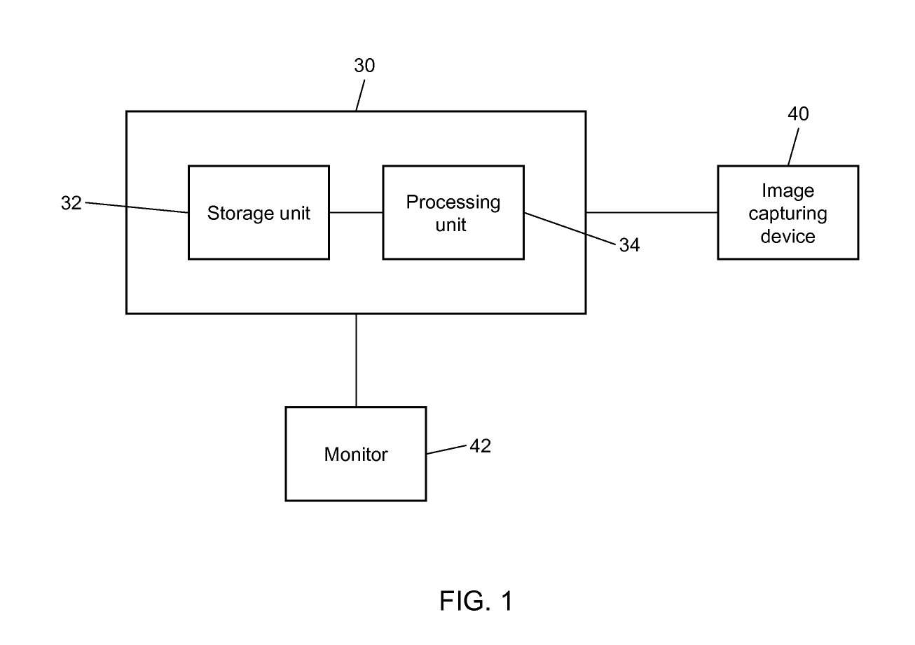

FIG. 1 is a block diagram of an image processor 30 in an embodiment. The image processor 30 includes a storage unit 32 and a processing unit 34. The storage unit 32 stores fisheye images and part images. For example, the storage unit 32 can be a random access memory (RAM), a flash memory, or a hard disk drive (HDD). The processing unit 34 performs a fisheye image display method. In an embodiment, the fisheye image can be an original fisheye image captured by the fisheye lens, or an unfolded fisheye image generated by correcting the distortion of the original fisheye image by the processing unit 34. The original fisheye image and the unfolded fisheye image can be stored in the storage unit 32.

In some embodiments, the processing unit 34 further connects to an image capturing device 40. For example, the mage capturing device 40 can be an assembly of a set of lenses and a charge-coupled device (CCD), an assembly of a set of lenses and a complementary metal-oxide-semiconductor (CMOS), or an Internet protocol camera (IP camera). For example, the lens of the image capturing device 40 can be a fisheye lens.

In some embodiments, the image processor 30 can further connect to a monitor 42 to display the fisheye image.

In some embodiments, the image processor 30 can further connect to a server or a remote monitor through internet, thereby increasing the capability of the image processor 30 or the camera.

In some embodiments, the image processor 30 can be applicable to security surveillance products with multimedia stream technology, such as a digital video recorder (DVR), a network video recorder (NVR), an IP camera with video surveillance software, or any suitable electronic devices that support internet access and remote control.

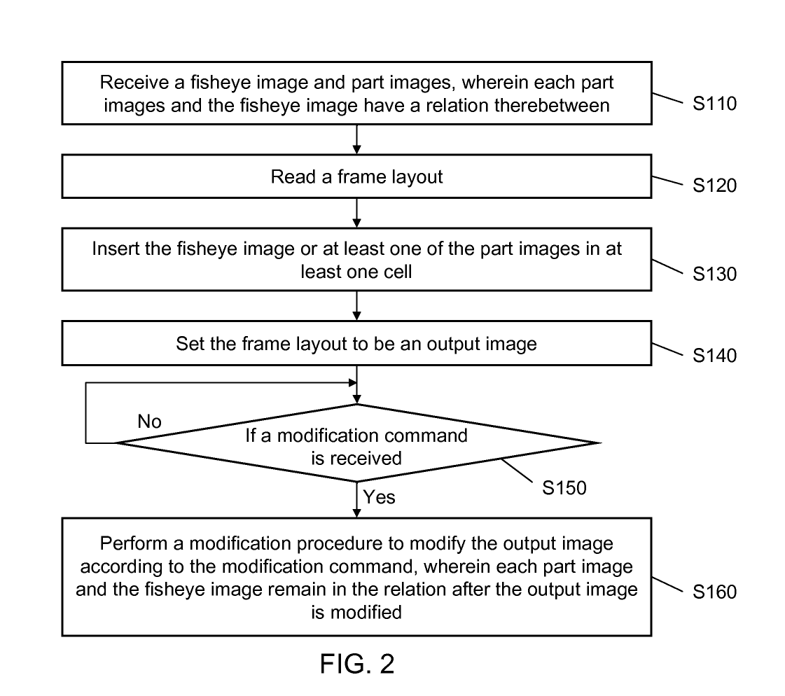

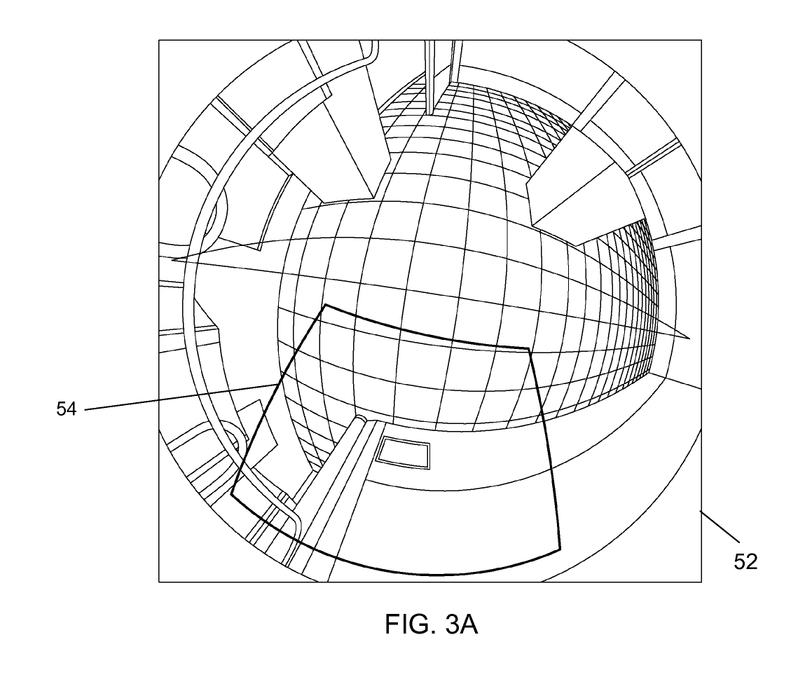

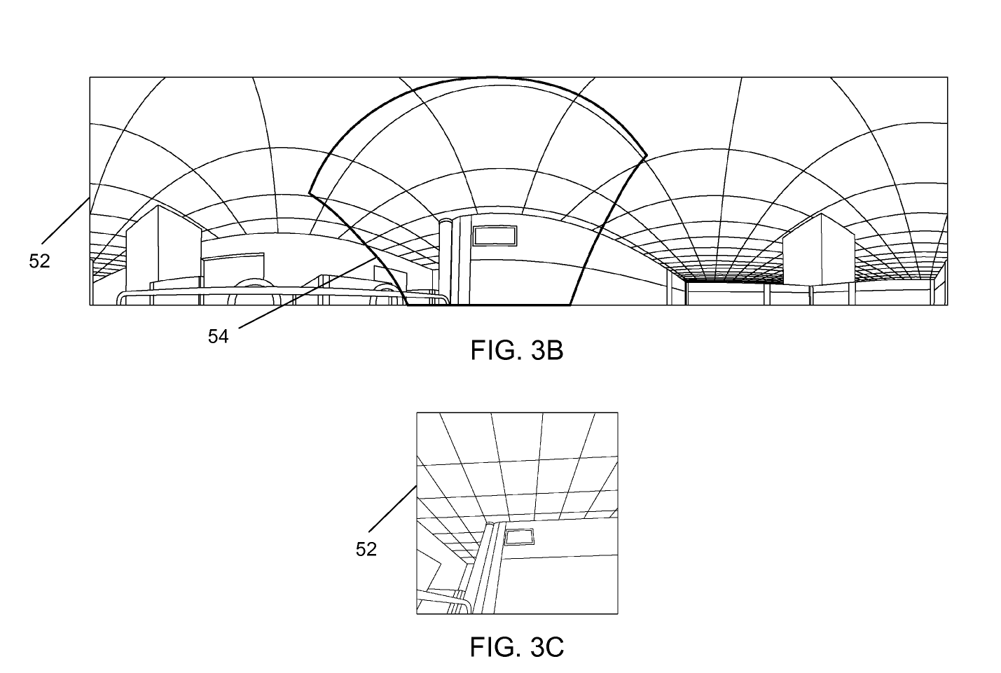

FIG. 2 is a flow chart of a fisheye image display method in an embodiment. The processing unit 34 may use a frame layout with at least one cell 52 as shown in FIG. 3A, FIG. 3B or FIG. 3C to display the fisheye image. The fisheye image display method includes the following steps.

First, the processing unit 34 receives the fisheye image and part images (Step 110), and each part image and the fisheye image have a relation therebetween. Specifically, the processing unit 34 may receive the fisheye image from the storage unit 32 or from the image capturing device 40, and receive the part images from the storage unit 32.

In particular embodiments, the fish image can be an original fisheye image or an unfolded fisheye image. In an embodiment, the original fisheye image is obtained by the image capturing device 40 with the fisheye lens with ultra wide angle, and is panoramic or hemispherical (e.g. has a spherical distorted appearance). In an embodiment, the unfolded fisheye image is obtained by correcting the distortion of the original fisheye image through the gnomonic projection method or other well-known de-warp methods. In this and some embodiments, the processing unit 34 may further perform one or more image procedures, such as file format conversion, resolution modulation, brightness calibration and color calibration, on the original fisheye image and/or the unfolded fisheye image.

In particular embodiments, the part image is part of the original fisheye image or unfolded fisheye image as shown in FIG. 3C, can show details of the fisheye image, for example, license number for cars or people's face. In order to obtain the part image, users can set a region of interest (ROI) 54 within the cell 52 containing the original fisheye image or unfolded fisheye image through a graphical user interface (GUI) as shown in FIG. 3A and FIG. 3B, and then the processing unit 34 extracts the part image corresponding to the region of interest 54. As an example and not by way of limitation, the processing unit 34 extracts the image of the region of interest 54 in the original fisheye image then correct the distortion of the extracted image into an unfolded part image (i.e. the part image) by using a gnomonic projection method or other known de-warp methods. As another example and not by way of limitation, the processing unit 34 directly extracts the image of the region of interest 54 in the unfolded fisheye image to be one part image. The image range of the part image is the range specified by the region of interest 54, so the part image corresponds to the fisheye image because of the region of interest 54.

Since the contents of the original fisheye image and the unfolded fisheye image are different, the locations of the regions of interest 54 in the original fisheye image and the unfolded fisheye image both of which correspond to the same part image will be different. For example, in FIGS. 3A and 3B, even though the location of the region of interest 54 in the original fisheye image shown in FIG. 3A and the location of the region of interest 54 in the unfolded fisheye image shown in FIG. 3B are different, these two regions of interest 54 still correspond to the same part image.

Furthermore, multiple regions of interest 54 can be set in a fisheye image, so one fisheye image can correspond to multiple part images.

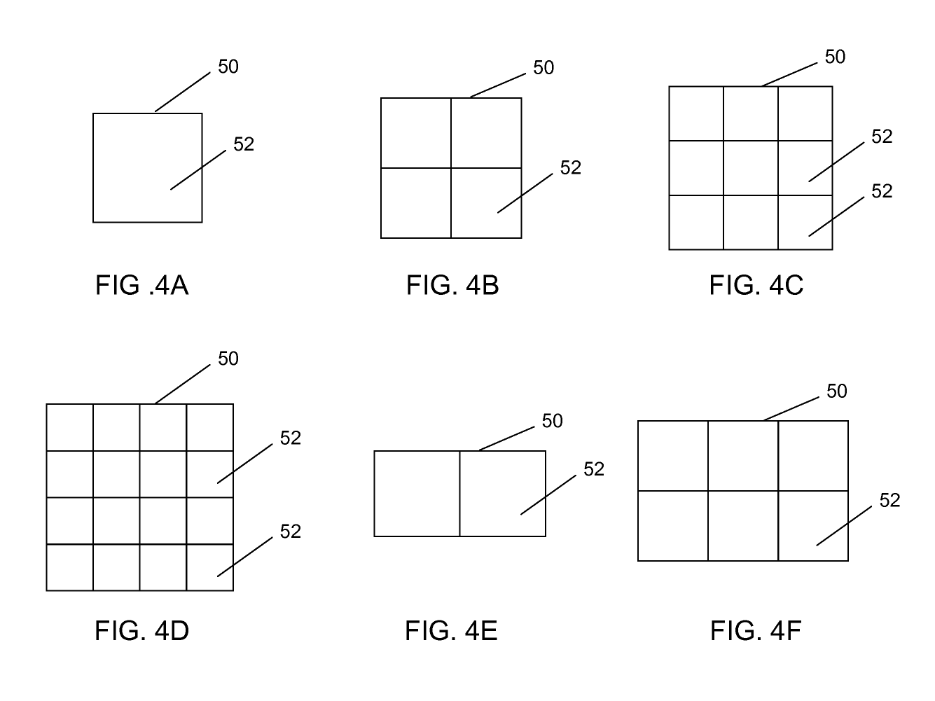

Subsequently, the processing unit 34 reads a frame layout 50 with at least one cell 52 (Step 120). As an example and not by way of limitation, the frame layout 50 may belong to one of the layout type, such as a 1×1 type in FIG. 4A, a 2×2 type in FIG. 4B, a 3×3 type in FIG. 4C, a 4×4 type in FIG. 4D, a 2×1 type in FIG. 4E, a 3×2 type in FIG. 4F, or any kinds of matrices constructed by cells 52. In other words, various layout types have different numbers and arrangements of cells in the frame layout 50.

After reading the frame layout 50, the processing unit 34 inserts the fisheye image or at least one of the part images in the at least one cell 52 (Step 130). In an embodiment, not every cell 52 has to be inserted with either the fisheye image or the part image. For example, the four cells 52 of the frame layout 50 in FIG. 4B have one inserted with the unfolded fisheye image, two inserted with part images, and the other one being blank.

After inserting the fisheye image or at least one of the part images in the at least one cell 52, the processing unit 34 outputs the frame layout 50 to be an output image (Step 140). The output image may further be displayed by the monitor 42.

After outputting the output image, the processing unit 34 determines whether a modification command is received or not (Step 150). As an example and not by way of limitation, the modification command may be an image shifting command, a scaling command, a switch command, a cell shifting command, a layout mode switch command, a layout type modification command, or a cell deleting command. As an example and not by way of limitation, the modification command is inputted via a graphical user interface (GUI). As an example and not by way of limitation, the modification command is inputted by directly clicking or dragging the cell 52 or the region of interest 54 shown by the GUI. As an example and not by way of limitation, the GUI may deliver the modification command to the processing unit 34 by using an interrupt.

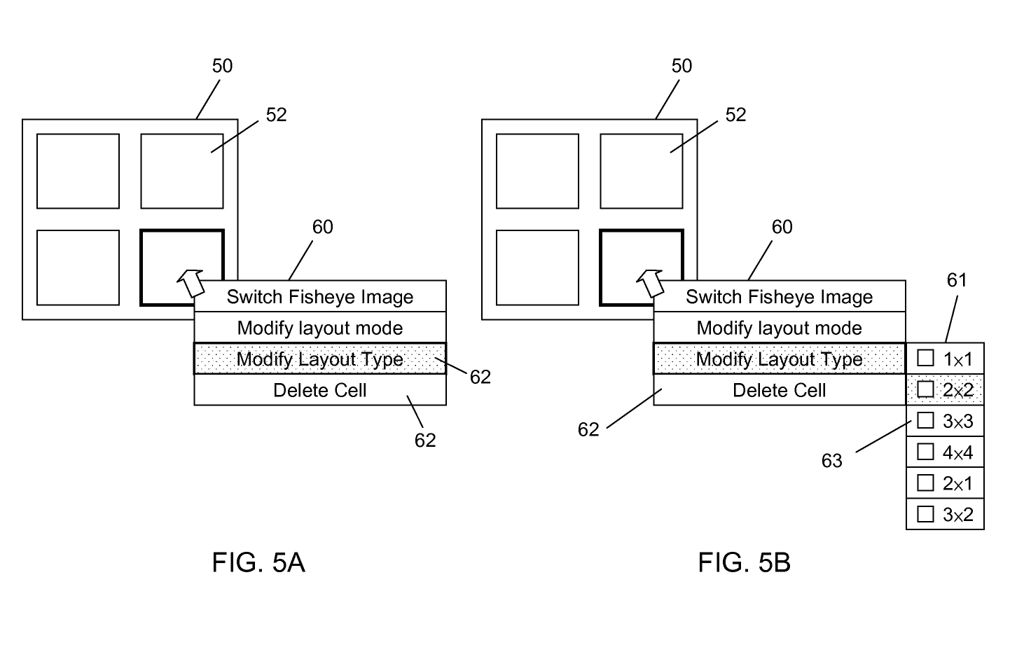

Referring to FIGS. 5A and 5B, when one cell 52 shown by the GUI is selected, a command list 60 with one or more command options 62 will be presented. For example, the command options 62 may include at least the above modification commands. In addition, when one command option 62 is selected, a corresponding sub command list 61 with command options 63 of, for example, “1×1”, “2×2”, “3×3”, “4×4”, “2×1” and “3×2” will be presented. The selected command option 62 or 63 defines the modification command.

If there is no modification command received, the processing unit 34 will continuously check for a modification command once per a specific period of time. If the processing unit 34 receives a modification command, the processing unit 34 will perform a modification procedure according to the modification command to modify the output image, and each part image and the fisheye image remain the relation (Step 160). Specifically, the processing unit 34 determines the received modification command and then performs the modification procedure specified by the modification command. Various embodiments of the modification procedure for modifying the frame layout 50 are described below.

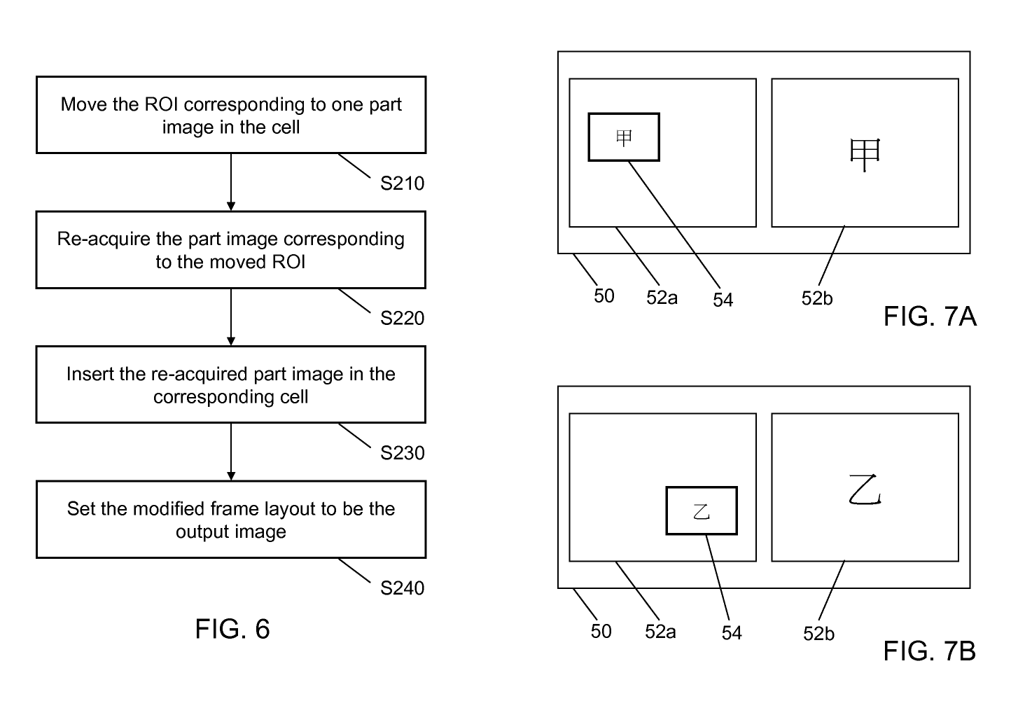

Referring to FIG. 6, FIG. 7A, and FIG. 7B, a modification procedure specified by an image shifting command is illustrated in an embodiment. When a user directly click and drag the region of interest 54 in the cell 52 presented by the GUI to change the location of the region of interest 54, the GUI will produce the image shifting command according to the user's operation. When the processing unit 34 receives the image shifting command, the processing unit 34 moves the region of interest 54 corresponding to one part image in the cell 52 (Step 210) and then re-acquires the part image corresponding to the moved region of interest 54 (Step 220). The processing unit 34 inserts the re-acquired part image in the corresponding cell 52 (Step 230) and then sets the modified frame layout 50 to be the output image (Step 240). More specifically, because the moved region of interest 54 corresponds to one of the part images in one cell 52 of the frame layout 50, the processing unit 34 can update the cell 52 with this part image.

As an example and not by way of limitation, FIG. 7A shows a frame layout 50 before the move of the region of interest 54, where the cell 52a displays a fisheye image and the cell 52b displays the part image corresponding to the region of interest 54. When the region of interest 54 in the frame layout 50 is moved, the region of interest 54 will be moved as well. Herein, the image specified by the moved region of interest 54 will then be changed. Subsequently, the processing unit 34 further receives the part image corresponding to the image specified by the moved region of interest 54, inserts this part image in the cell 52b to modify the output image, and then delivers the modified output image to the monitor 42.

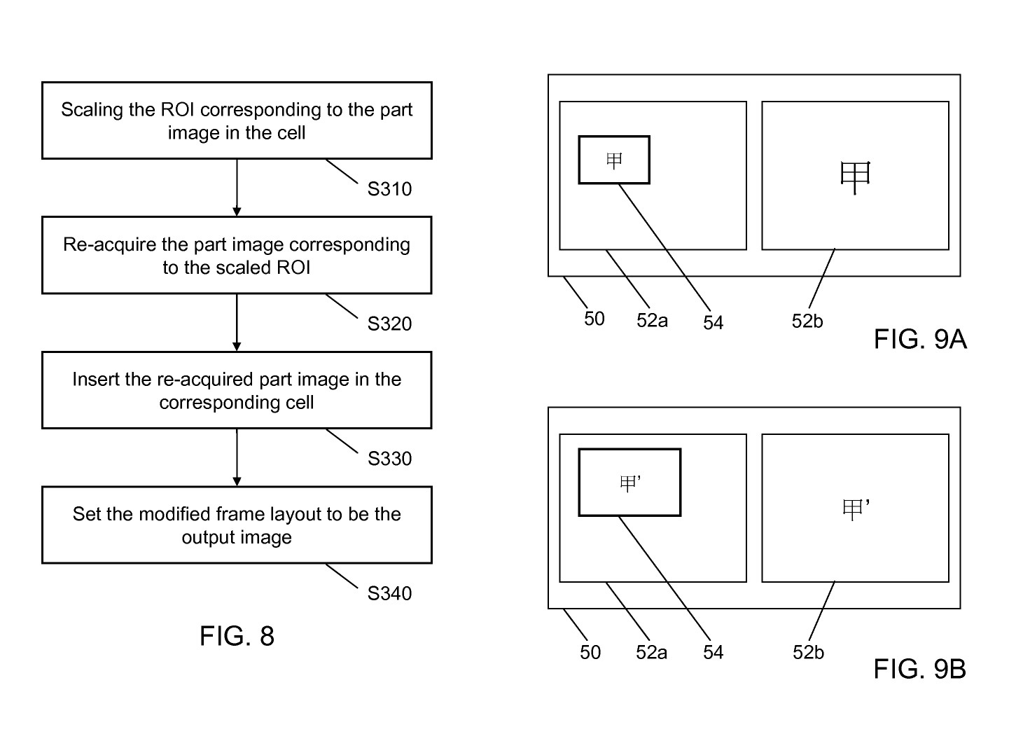

Referring to FIG. 8, FIG. 9A, and FIG. 9B, a modification procedure specified by a scaling command is illustrated in an embodiment. When a user selects and changes the size of the region of interest 54 in the cell 52 displayed by the GUI, the GUI produces the scaling command according to the user's operation. After the processing unit 34 receives the scaling command, the processing unit 34 scales up or down the region of interest 54 that corresponds to the part image in one of the cells 52 (Step 310), and then re-acquires the part image corresponding to the scaled region of interest 54 (Step 320). The processing unit 34 further inserts the re-acquired part image in the corresponding cell 52 (Step 330) and then sets the modified frame layout 50 to be the output image (Step 340). More specifically, because the scaled region of interest 54 corresponds to one of the part images in the frame layout 50, the processing unit 34 can update the cell 52 with this part image. When the region of interest 54 is scaled up, the range of the scaled region of interest 54 will be larger. When the region of interest 54 is scaled down, the range of the scaled region of interest 54 will be smaller.

As an example and not by way of limitation, FIG. 9A shows a frame layout 50 before being scaled, where the cell 52a displays the fisheye image and the cell 52b displays the part image corresponding to the region of interest 54. FIG. 9B shows a frame layout 50 after being scaled, when the frame layout 50 is scaled up, the region of interest 54 will be scaled up as well. Herein, the image specified by the scaled region of interest 54 will be changed. Subsequently, the processing unit 34 receives the part image corresponding to the image specified by the scaled region of interest 54, inserts the part image in the cell 52b to modify the output image, and then delivers the modified output image to the monitor 42.

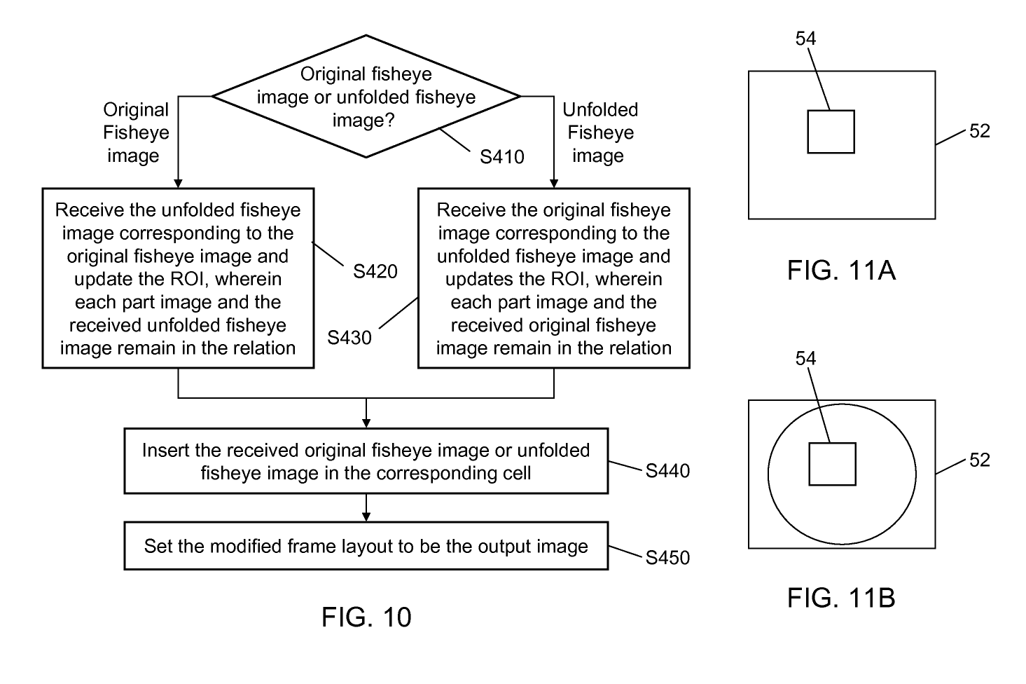

Referring to FIG. 10, FIG. 11A, and FIG. 11B, a modification procedures specified by a switch command is illustrated in an embodiment. When a user selects one cell 52 shown by the GUI, a command list 60 in FIG. 5A will be presented. After the command option 62 of “Switch Fisheye Image” is selected, the GUI produces the switch command according to the user's operation. When the processing unit 34 receives the switch command, the processing unit 34 determines whether the fisheye image in the selected cell 52 is an original fisheye image or an unfolded fisheye image (Step 410).

When the fisheye image in the selected cell 52 is an original fisheye image, the processing unit 34 receives the unfolded fisheye image corresponding to the original fisheye image and updates the region of interest 54 in the selected cell 52, so that each part image and the received unfolded fisheye image remain in the relation (Step 420).

For the original fisheye image and the unfolded fisheye image, their regions of interest 54 corresponding to the same part image may be in different locations. Thus, after the processing unit 34 replaces the original fisheye image in the cell 52 with the corresponding unfolded fisheye image, the region of interest 54 will not stay at the previous location in the cell 52. In other words, the processing unit 34 will update the location of the region of interest 54 according to the relation between the received unfolded fisheye image and the part image. As a result, this part image still matches the image specified by the updated region of interest 54 in the unfolded fisheye image.

Similarly, when the fisheye image in the selected cell 52 is an unfolded fisheye image, the processing unit 34 receives the original fisheye image corresponding to the unfolded fisheye image and updates the region of interest 54 in the selected cell 52 and each part image and the received original fisheye image remain in the relation (Step 430).

Then, the processing unit 34 inserts the received original fisheye image or unfolded fisheye image in the corresponding cell 52 (Step 440) and then sets the modified frame layout 50 to be the output image (Step 450).

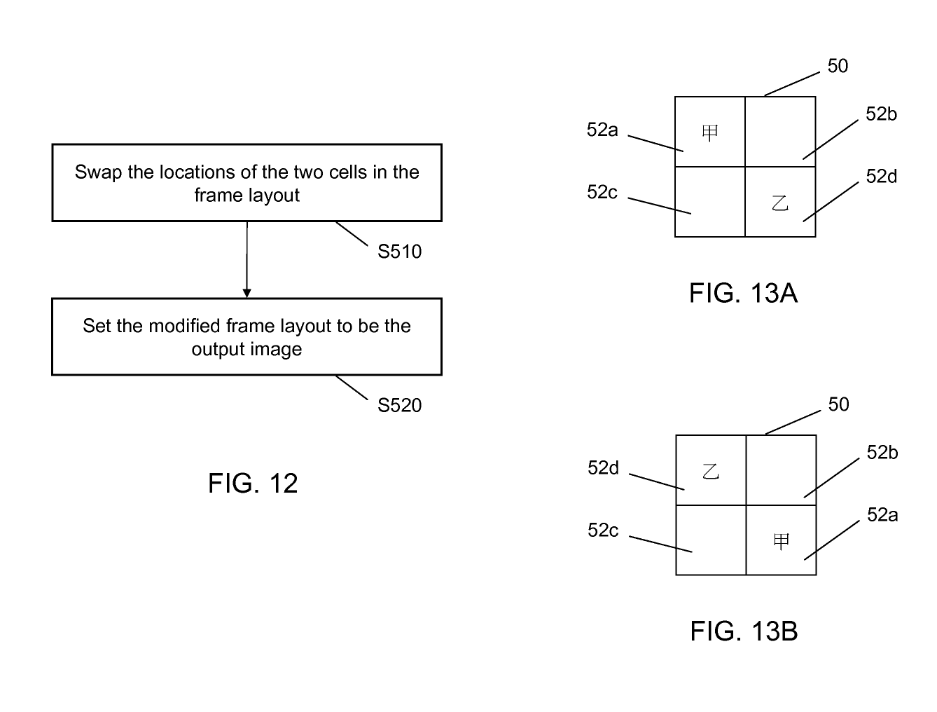

Referring to FIG. 12, FIG. 13A, and FIG. 13B, a modification procedure specified by a cell shifting command is illustrated in an embodiment. When a user selects and moves one cell 52 to partially or completely cover another cell 52 to make the selected cell 52 partially or completely overlap the another cell 52 via the GUI, the GUI will produce the cell shifting command according to the user's operation. Because the processing unit 34 calculates the area of the two overlapped cells 52, only when the overlapped area is greater than a threshold value, the cell shifting command will be effective. Alternately, the user can select two different cells 52 successively, so that the GUI will produce the cell shifting command according to the user's operation.

When the processing unit 34 receives the cell shifting command, the processing unit 34 swaps the locations of the two cells 52 in the frame layout 50 (Step 510) and then sets the modified frame layout 50 to be the output image (Step 520). In other words, the processing unit 34 swaps the location of the moved cell 52 and the covered cell 52 in the frame layout 50, or swaps the location of the two selected cells 52 in the frame layout 50. As an example and not by way of limitation, the locations and images of two (e.g. cells 52a and 52d) of four cells 52a, 52b, 52c and 52d in the frame layout 50 in FIG. 13A are exchanged as shown in FIG. 13B after the execution of the cell shifting command.

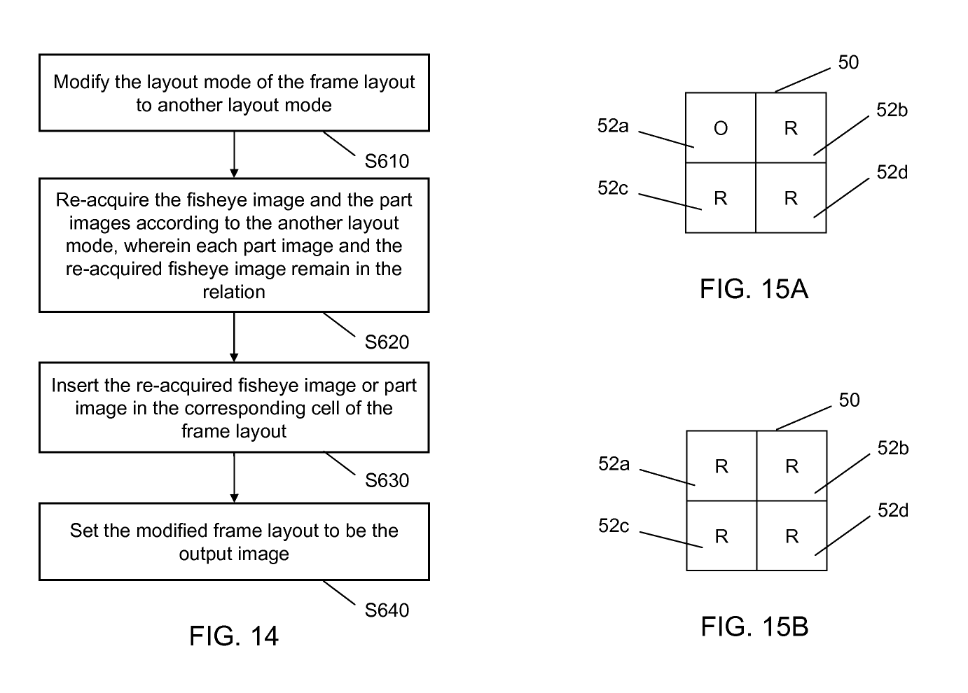

Referring to FIG. 14, FIG. 15A, and FIG. 15B, a modification procedure specified by a layout mode switch command is illustrated in an embodiment. When a user selects the instruction option 62 of “Modify Layout Mode” in the command list 60 shown in the GUI in FIG. 5A, the GUI will produce the layout mode switch command according to the user's operation. As an example and not by way of limitation, the layout modes, which specify different arrangements and kinds of images shown in the frame layout 50, may be a single-original-image mode, a single-planar-image mode, a single-part-image mode, a single-original-image and three-part-images mode, a single-planar-image and three-part-images mode, a four-part-images mode, a single-original-image and eight-part-images mode, or a double-planar-images mode. The single-original-image mode indicates that there is only one cell 52 in the frame layout 50 and the cell 52 is inserted with the original fisheye image. The single-original-image and three-part-images mode indicates that there are four cells 52 in the frame layout 50, where one of the cells 52 is inserted with the original fisheye image and the other three cells 52 are inserted with part images. The single-original-image and eight-part-images mode indicates that there are nine cells 52 in the frame layout 50, where one of the cells 52 is inserted with the original fisheye image and the other eight cells are inserted with part images. The rest of the layout modes except the double-planar-image mode may be deduced by analogy. The double-planar-image mode indicates that the frame layout 50 has two cells 52, which are inserted with different unfolded fisheye images respectively.

In some embodiments, when the image processor 30 connects with multiple image capturing devices 40, the same frame layout 50 may be inserted with one or more fisheye images (i.e. one or more original fisheye images or one or more unfolded fisheye images) or one or more part images obtained from the different image capturing devices 40 at the same time.

When processing unit 34 receives the frame layout mode switch command, the processing unit 34 modifies the layout mode of the frame layout 50 to another layout mode (Step 610) and then re-acquires the fisheye image and the part images according to the another layout mode (Step 620), where each part image and the re-acquired fisheye image remain in the relation. In other words, even if the current frame layout is replaced by another layout mode, the relation between the part image and the re-acquired fisheye image will not be reset, changed or removed.

Subsequently, the processing unit 34 inserts the re-acquired fisheye image or part image in the corresponding cell 52 of the frame layout 50 (Step 630) and then sets the modified frame layout 50 to be the output image (Step 640). For example, the frame layout 50 in FIG. 15A is in the single-original-image and three-part-images mode, and the layout mode of the frame layout 50 is modified to being the four-part-image mode as shown in FIG. 15B.

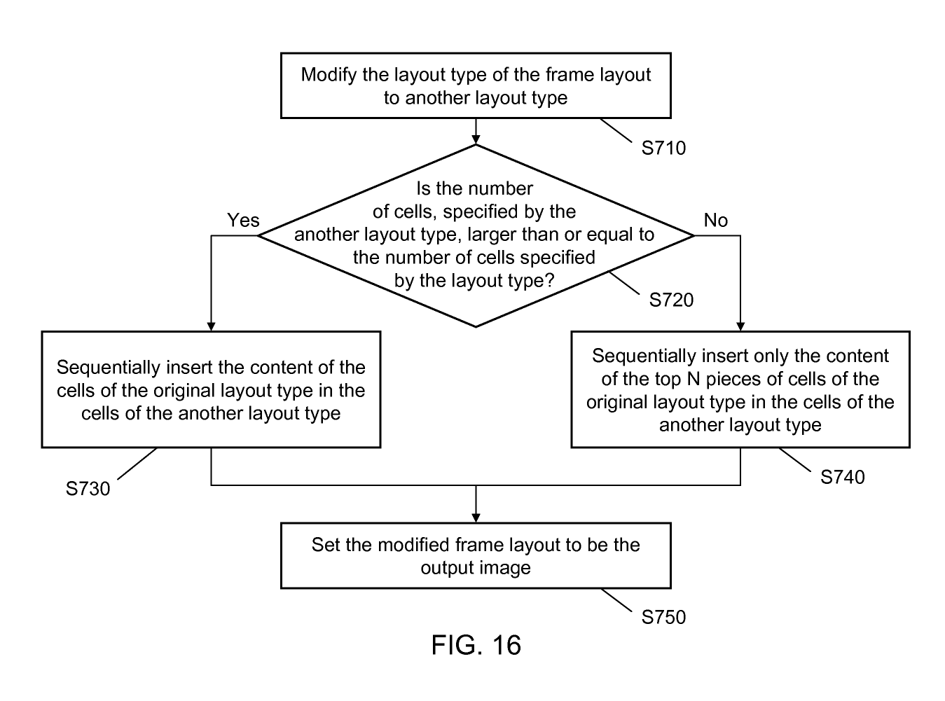

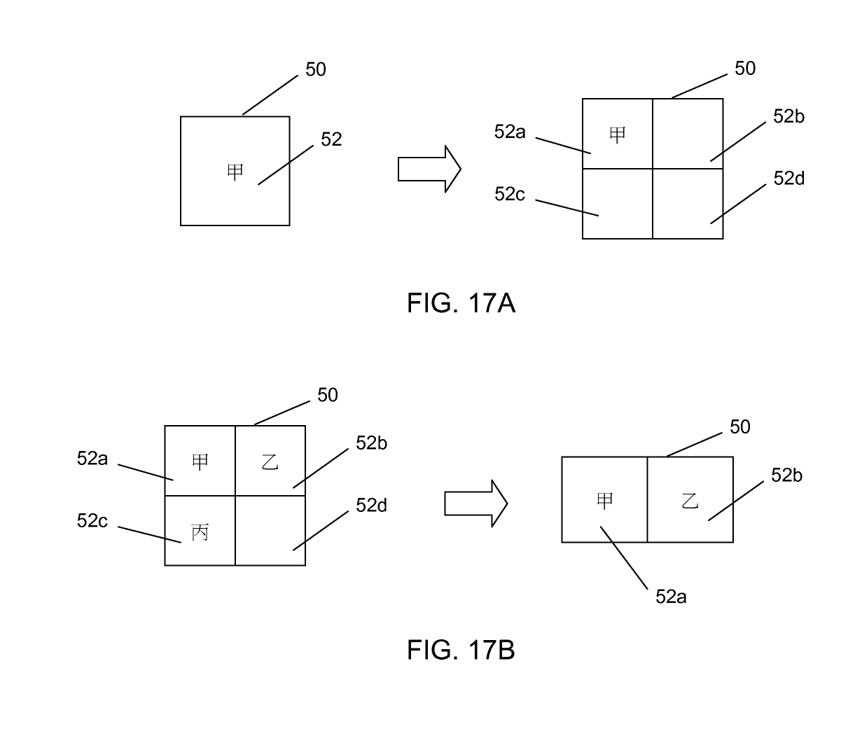

Referring to FIG. 16, FIG. 17A, and FIG. 17B, a modification procedure specified by a layout type switch command is illustrated in an embodiment. When a user selects one command option 62 of “Modify Layout Type” in the command list 60 shown in FIG. 5A via the GUI, the GUI will produce the layout type modification command according to the user's operation. When the processing unit 34 receives the layout type modification command, the processing unit 34 will modify the layout type of the frame layout 50 to another layout type (Step 710). Since different types of frame layout 50 may specify different numbers of cells 52, the processing unit 34 determines whether the number of cells 52 specified by another layout type is larger than or equal to the number of cells 52 specified by the layout type (Step 720).

When the number of cells 52 specified by the another layout type is larger than or equal to the number of cells 52 specified by the layout type, the content of the original cells 52 will sequentially be inserted in the cells 52 of the frame layout 50 of the another layout type (Step 730). In other words, all the content of the original cells 52 will be inserted in the modified frame layout 50. For example, in FIG. 17A, the original layout type and the another layout type specify one cell 52 and four cells 52 respectively, so the image in the cell 52 of the original frame layout 50 can be inserted in the cell 52a of the modified frame layout 50. In contrast, when the number of cells 52 specified by the another layout type is less than the number of cells 52 specified by the layout type, only the content of the top N pieces of original cells 52 in the original frame layout 50 can sequentially be inserted in the cells 52 of the modified frame layout 50 (S740), where N is equal to the number of cells in the modified frame layout 50. Specifically, because each cell 52 has its identification code, the processing unit 34 can select the N pieces of cells 52 from the smallest identification code to the largest identification code, and maintain the content of the N cells 52 in the modified frame layout 50. In other words, the images to be inserted in the cells are selected according to the number of cells in the modified frame layout 50. For example, in FIG. 17B, when the original frame layout 50 in which there are three fisheye images or part images inserted in the three original cells 52, is converted to the modified frame layout 50 having only two cells 52, the processing unit 34 will preserve the content of the top two cell 52a and cell 52b in the modified frame layout 50.

Then, the processing unit 34 sets the modified frame layout 50 to be the output image (Step 750).

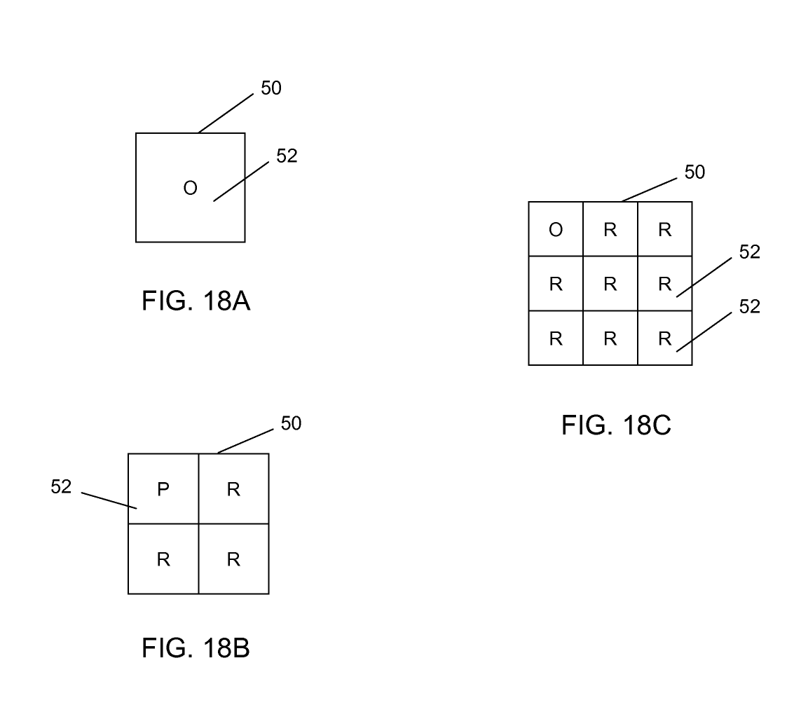

Furthermore, in some embodiments, the disclosure can simultaneously perform the layout mode switch command and the layout type switch command. As an example and not by way of limitation, when modifying the frame layout 50 from the single-original-image mode shown in FIG. 18A to the single-planar-image and three-part-images mode shown in FIG. 18B, the processing unit 34 will first modify the layout type from the 1×1 type to the 2×2 type and then modify the layout mode to be the single-planar-image and three-part-images mode. As another example and not by way of limitation, when modifying the frame layout 50 from the single-planar-image and three-part-images mode shown in FIG. 18B to the single-original-image and eight-part-images mode shown in FIG. 18C, the processing unit 34 will first modify the layout type from the 2×2 type to the 3×3 type and then modify the layout mode to be the single-original-image and eight-part-images mode.

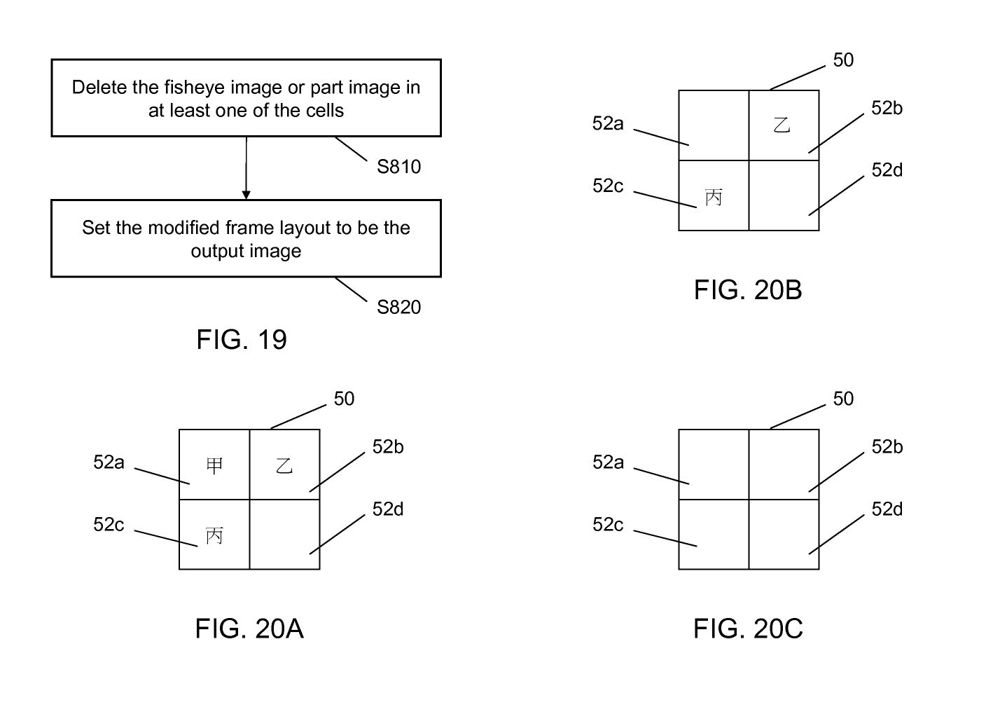

Referring to FIG. 19, FIG. 20A, FIG. 20B, and FIG. 20C, a modification procedure specified by a cell deleting command is illustrated in an embodiment. When a user selects one cell 52 and then selects one command option 62 of “Delete Cell” in the command list 60 shown in FIG. 5A via the GUI, the GUI will produce the cell deleting command according to the user's operation. When the processing unit 34 receives the cell deleting command, the processing unit 34 deletes the fisheye image or part image in at least one of the cells 52 (Step 810) and then sets the modified frame layout 50 to be the output image (Step 820).

For example, the cell 52a, 52b, and 52c in FIG. 20A have already been inserted with the fisheye image or the part image before the executing of the cell deleting command. If a user selects the cell 52a and inputs the cell deleting command, the processing unit 34 will delete the image in the cell 52a as shown in FIG. 20B. Alternately, the user can input an empty command via the GUI to delete all of the images in the cells 52, as shown in FIG. 20C.

In some embodiments, multiple modification commands can be inputted successively, so that the processing unit 34 will perform multiple modification procedures corresponding to these modification commands successively. For example, the processing unit 34 in order sets the frame layout 50 to be in the single-original-image and three-part-images mode, changes the image from the original fisheye image to the unfolded fisheye image, moves the region of interest 54, scales down the region of interest 54, and modifies the layout mode to be the single-planar-image and three-part-images mode according to the corresponding modification commands. Even thought the frame layout 50 goes through these modification procedures, each part image and the fisheye image still remain in the same relation.

As described above, the image processor performs the fisheye image display method to provide multiple layout types and layout modes for selection and display the original fisheye image, unfolded fisheye image, or part image according to the selection result. Moreover, after performing the selection or modification of the layout type or layout mode, the image processor can further perform the image shifting command, the scaling command, the order switching, the cell shifting command, the layout mode switch command, the layout type modification command, or the cell deleting command to freely adjust the arrangement of the frame layout and the region of interest. Therefore, the image processor and its fisheye image display method may provide users a faster, simpler, more flexible and straightforward operation way to fulfill the needs of the users. This faster and more flexible way of displaying fisheye images may not only speed up the process of setting the frame layout and adjusting the image, but also make the user's operation more convenient.

What is claimed is:

1. A fisheye image display method for an image processor, comprising:
receiving a fisheye image and a plurality of part images, wherein each of the part images and the fisheye image have a relation therebetween;
reading a frame layout which comprises at least one cell;
inserting the fisheye image or at least one of the part images in the at least one cell;
setting the frame layout to be an output image;
receiving a modification command; and
performing a modification procedure to modify the output image according to the modification command, wherein each of the part images and the fisheye image remain in the relation after the output image is modified.

2. The fisheye image display method of claim 1, wherein the fisheye image is an original fisheye image or an unfolded fisheye image, the fisheye image comprises a plurality of regions of interest, the part images respectively correspond to the regions of interest, the modification command is a switch command, and the modification procedure comprises:
re-acquiring the unfolded fisheye image that corresponds to the original fisheye image and updating the regions of interest when the fisheye image is the original fisheye image, so that each of the part images and the re-acquiring unfolded fisheye image remain in the relation;
re-acquiring the original fisheye image that corresponds to the unfolded fisheye image and updating the regions of interest when the fisheye image is the unfolded fisheye image, so that each of the part images and the re-acquiring original fisheye image remain in the relation;
inserting the re-acquiring original fisheye image or the re-acquiring unfolded fisheye image in the at least one cell; and
setting the frame layout modified to be the output image.

3. The fisheye image display method of claim 1, wherein the fisheye image is an original fisheye image or an unfolded fisheye image, the fisheye image comprises a plurality of regions of interest, the part images respectively correspond to the regions of interest, a number of the at least one cell is greater or equal to 2, the modification command is a cell shifting command, and the modification procedure comprises:
swapping positions of two of the cells in the frame layout; and
setting the frame layout modified to be the output image.

4. The fisheye image display method of claim 1, wherein the frame layout is implemented in one of a plurality of layout modes which specify different arrangements and kinds of images shown in the frame layout.

5. The fisheye image display method of claim 4, wherein the modification command is a layout mode switch command, and the modification procedure comprises:
modifying the layout mode of the frame layout;
re-acquiring the fisheye image and at least one of the part images according to the modified layout mode, wherein the at least one re-acquired part image and the re-acquired fisheye image remain in the relation;
inserting the re-acquired fisheye image or the at least one re-acquired part image in the at least one corresponding cell of the frame layout; and
setting the frame layout under the modified layout mode to be the output image.

6. The fisheye image display method of claim 1, wherein the frame layout belongs to one of a plurality of layout types, the layout types have different numbers and arrangements of the at least one cell of the frame layout.

7. The fisheye image display method of claim 6, wherein the modification command is a layout type modification command, and the modification procedure comprises:
modifying the layout type of the frame layout to another layout type;
sequentially inserting content of the at least one cell in the layout type in the at least one cell of the frame layout in the another layout type when the number of the at least one cell in the another layout type is larger than or equal to the number of the at least one cell in the layout type;
sequentially inserting content of top N of the at least one cell in the layout type in the at least one cell of the frame layout in the another layout type when the number of the at least one cell in the another layout type is less than the number of the at least one cell in the layout type, wherein N is equal to the number of the at least one cell in the another layout type; and
setting the frame layout in the another layout type to be the output image.

8. The fisheye image display method of claim 1, wherein the modification command is a cell deleting command, and the modification procedure comprises:
deleting the fisheye image or the part image in the at least one cell; and
setting the frame layout modified to be the output image.

9. An image processor comprising:
a storage unit for storing a fisheye image and a plurality of part images, wherein each of the part images and the fisheye image have a relation therebetween; and
a processing unit for performing the following steps:
receiving the fisheye image and the part images from the storage unit;
reading a frame layout which comprises at least one cell;
inserting the fisheye image or at least one of the part images in the at least one cell;
setting the frame layout to be an output image;
receiving a modification command; and
performing a modification procedure to modify the output image according to the modification command, wherein each of the part images and the fisheye image remain in the relation after the output image is modified.

10. The image processor of claim 9, wherein the fisheye image is an original fisheye image or an unfolded fisheye image, the fisheye image comprises a plurality of regions of interest, the part images respectively correspond to the regions of interest, the modification command is a switch command, and the modification procedure comprises:
re-acquiring the unfolded fisheye image that corresponds to the original fisheye image and updating the regions of interest when the fisheye image is the original fisheye image, so that each of the part images and the re-acquiring unfolded fisheye image remain in the relation;
re-acquiring the original fisheye image that corresponds to the unfolded fisheye image and updating the regions of interest when the fisheye image is the unfolded fisheye image, so that each of the part images and the re-acquiring original fisheye image remain in the relation;
inserting the re-acquiring original fisheye image or the re-acquiring unfolded fisheye image in the at least one cell; and
setting the frame layout modified to be the output image.

11. The image processor in claim 9, wherein the fisheye image is an original fisheye image or an unfolded fisheye image, the fisheye image comprises a plurality of regions of interest, the part images respectively correspond to the regions of interest, a number of the at least one cell is greater or equal to 2, the modification command is a cell shifting command, and the modification procedure comprises:
swapping positions of two of the cells in the frame layout; and
setting the frame layout modified to be the output image.

12. The image processor in claim 9, wherein the frame layout is implemented in one of a plurality of layout modes which specify different arrangements and kinds of images shown in the frame layout.

13. The image processor in claim 12, wherein the modification command is a layout mode switch command, and the modification procedure comprises:
modifying the layout mode of the frame layout to another layout mode;
re-acquiring the fisheye image and at least one of the part images according to the modified layout mode, wherein the at least one re-acquired part image and the re-acquiring fisheye image remain in the relation;
inserting the re-acquired fisheye image or the at least one re-acquired part image in the at least one cell of the modified frame layout; and
setting the frame layout under the modified layout mode to be the output image.

14. The image processor in claim 9, wherein the frame layout belongs to one of a plurality of layout types, the layout types have different numbers and arrangements of the at least one cell of the frame layout.

15. The image processor of claim 14, wherein the modification command is a layout type modification command, and the modification procedure comprises:
modifying the layout type of the frame layout to another layout type;
sequentially inserting content of the at least one cell in the layout type in the at least one cell of the frame layout in the another layout type when the number of the at least one cell in the another layout type is larger than or equal to the number of the at least one cell in the layout type;
sequentially inserting content of top N of the at least one cell in the layout type in the at least one cell of the frame layout in the another layout type when the number of the at least one cell in the another layout type is less than the number of the at least one cell in the layout type, wherein N is equal to the number of the at least one cell in the another layout type; and
setting the frame layout in the another layout type to be the output image.

16. The image processor of claim 9, wherein the modification command is a cell deleting command, and the modification procedure comprises:
deleting the fisheye image or the part image in the at least one cell; and
setting the frame layout modified to be the output image.
